(19) United States
(12) Patent Application Publication
(10) Pub. No.: US 2016/0282979 A1
(43) Pub. Date: Sep. 29, 2016

(54) HUMAN BODY COMMUNICATION WITH TOUCH DEVICES

(71) Applicant: Intel Corporation, Santa Clara, CA (US)

(72) Inventors: Anand S. Konanur, Sunnyvale, CA (US); Shwetank Kumar, San Francisco, CA (US); Anchit Dixit, Fremont, CA (US); Rohit Mittal, Sunnyvale, CA (US); Jaroslaw J. Sydir, San Jose, CA (US); Chia-Yun Kuan, Sunnyvale, CA (US)

(21) Appl. No.: 14/667,873

(22) Filed: Mar. 25, 2015

(51) Int. Cl. G06F 3/044; G09G 5/00; G06F 3/01

(52) U.S. Cl. CPC G06F 3/044; G06F 3/014; G09G 5/003; G09G 2370/16

(57) ABSTRACT

Systems, apparatuses, and methods may include a touch device having conductive traces to receive human body communication signals and user selection signals such that the human body communication signals are multiplexed with the user selection signals on the conductive traces. A processor receives the human body communication signals and the user selection signals.

### TECHNICAL FIELD

Embodiments generally relate to human body communication. More particularly, embodiments relate to human body communication with touch devices.

### BACKGROUND

Human body communication is a communication technology in which a signal is coupled directly onto a human body by a transmitter through a transmission electrode; it is transmitted by the body to its destination. The signal may be delivered to a device via a body member contacting a receiving pad on the device. The transmission electrode may be a capacitively coupled electrode and the receiving pad may be a capacitive pad. Human body communication transmitters and receivers typically touch the skin or are in close proximity to the skin.

To allow communication between a human body communication transmitter and a touch device, a capacitive pad may be incorporated into the touch device in a location accessible to touch but isolated from the chassis and from other components. This may require a user to touch the capacitive pad to transmit a human body communication signal and to touch a touchscreen of a touch device to make a user input selection.

### BRIEF DESCRIPTION OF THE DRAWINGS

The various advantages of the embodiments will become apparent to one skilled in the art by reading the following specification and appended claims, and by referencing the following drawings, in which:

FIG. 1 is a perspective view of an example of a system including a touch device and a human body communication device according to an embodiment;

FIG. 2 is a perspective view of an example of a user interacting with a touch device; according to an embodiment;

FIG. 3 is a schematic diagram of an example of a touch device;

FIG. 4 is flowchart of a method according to an embodiment;

FIG. 5 is an example of a signal processing model for a touch device of an embodiment; and

FIG. 6 is an example of a method to distinguish a user selection signal from a human body communication signal according to an embodiment.

### DESCRIPTION OF EMBODIMENTS

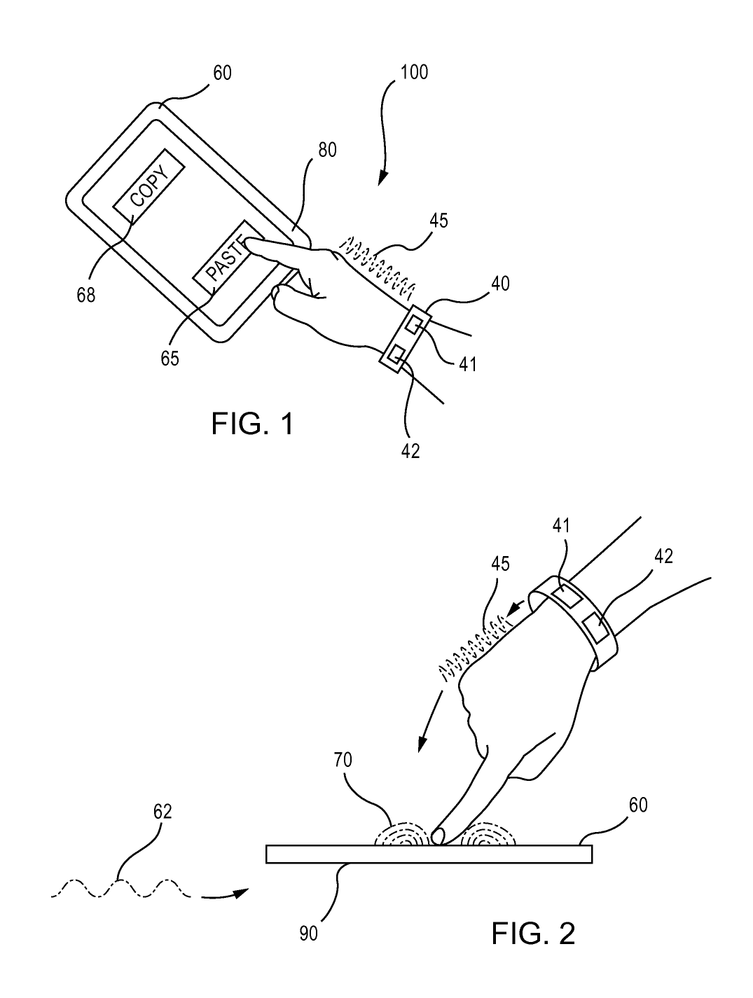

Turning to the drawings in detail, FIG. 1 depicts an example of a human body communication system 100 including a human body communication device 40 and a touch device 60 according to an embodiment. The human body communication device 40 is depicted in this embodiment as a wearable bracelet; however, the human body communication device 40 may be any device that facilitates communication using the human body as a transmission path. Thus, examples of the human body communication device 40 may be wearable devices such as rings, necklaces, eyeglasses, and clothing, but not limited thereto. The touch device 60 may be any device capable of receiving user input through touch including touch devices based on resistance, capacitance, optics, sound or any other device that can discern user input from touch. The touch device 60 may be a device having computing functionality (e.g., server, workstation, desktop computer, personal digital assistant/PDA, notebook computer, smart tablet), communications functionality (e.g., wireless smart phone), imaging functionality, media playing functionality (e.g., smart television/TV), or any combination thereof (e.g., mobile Internet device/MID). The human body communication device may include a human body communication transmitter/receiver 41 and a wireless transmitter/receiver 42 (to be discussed in further detail below).

As seen in FIG. 1, a user body part 80 is touching a selection region 65 of the touch device 60. For example, the touch selection region 65 may indicate a paste operation. In the example shown, the touch by the user body part 80 transfers a human body communication signal 45 from the human body communication transmitter/receiver 41 to the touch device 60 as well as selecting the paste operation of the selection region 65. In this manner, a single touch may cause data from a human body communication signal to be pasted to the touch device 60. In a similar manner, a user touch of a second touch selection region 68 that indicates a copy operation may cause data to be transmitted from the touch device 60 via the user body part 80 to the human body communication device 40. That is, the system is fully bidirectional. Data may be transferred to or from the human body communication device 40 via the touch device 60.

For touch devices that accept multitouch input, unique touch gestures may differentiate between various user-controlled selections. For example, gestures may be used to distinguish between copy and paste operations. As an example, selecting an area of a touch device 60 with two fingers, one from each hand, may signify a copy operation while pressing a target area with one finger (or two fingers of the same hand) would signify paste.

FIG. 2 schematically depicts an exemplary human body communication signal 45 having a frequency on the order of 1 to 60 MHz. In the touch device 60, a conductive trace 90 carries a user selection signal 62 on the order of hundreds of kHz, such as approximately 100 to 900 kHz as will be discussed in further detail below. An electric field 70 may result from the human body communication signal 45 and the user selection signal 62.

In an alternative, for large amounts of data, the human body communication signal 45 may indicate that data will be transmitted from the human body communication device 40 through a wireless transmission from the wireless transmitter/receiver 42 positioned on the human body communication device 40. Alternatively, wireless transmission may be established with another device that is able to communicate with the human body communication device 40 such as a smartphone or a further human body communication device. The wireless transmission may be through any wireless protocol including, but not limited to, cellular telephone protocols (e.g., Wideband Code Division Multiple Access/W-CDMA (Universal Mobile Telecommunications System/UMTS), CDMA2000 (IS-856/IS-2000), etc.), WiFi (Wireless Fidelity, e.g., Institute of Electrical and Electronics Engineers/IEEE 802.11-2007, Wireless Local Area Network/LAN Medium Access Control (MAC) and Physical Layer (PHY) Specifications), 4G LTE (Fourth Generation Long Term Evolution), Bluetooth (e.g., IEEE 802.15.1-2005, Wireless Personal Area Networks), WiMax (e.g., IEEE 802.16-2004, LAN/MAN Broadband Wireless LANS), Global Positioning System (GPS), spread spectrum (e.g., 900 MHz), Zigbee, Near Field Communication (e.g., ISO/IEC 14443 and FeliCa). Note that these protocols may also be used to generate the human body communication signal 45.

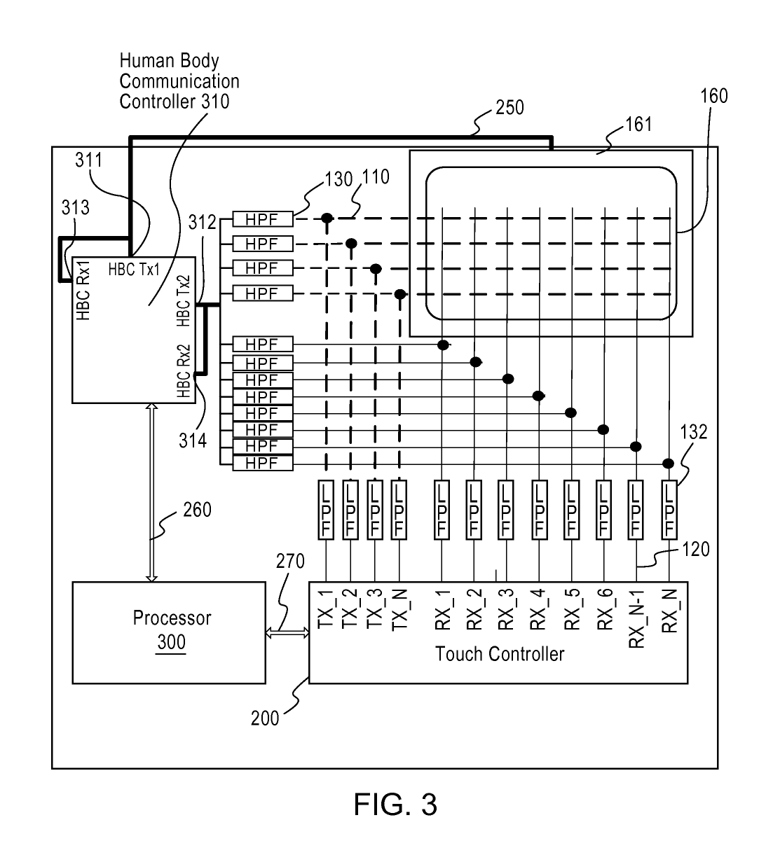

With continuing reference to FIGS. 2 and 3, FIG. 3 depicts a more detailed example of a touch device 160 having conductive traces in an x-direction, that is, x traces 110, and conductive traces in a y-direction, that is, y traces 120. For the touch device 160, x traces 110 and y traces 120 are typically transparent conductors such as indium tin oxide although other materials may be used. Signals may be sent across, for example, the x traces 110 of the touch device 160 and may be monitored by the y traces 120 (or vice versa). Introduction of the user body part 80 may perturb some set of these signals. This perturbed set of signals may map to a physical location (typically at the intersection of a pair of one of the x traces 110 and one of the y traces 120) on the screen. This signal perturbation may be caused by a change in a property, such as a change in resistance or a change in capacitance due to the touch of the user body part 80.

The x traces 110 and y traces 120 may communicate with a touch controller 200. The touch controller 200 may determine the location of the touch that is made by the user body part 80. The x traces 110 and y traces 120 may also communicate with a human body communication controller 310 that receives or transmits data. In transmission, the data may be sent by the human body communication controller 310 over the traces to be transmitted through the user body part 80 back to the human body communication device 40. In reception, the data may be received from the traces, through the user body part 80 and conducted to the human body communication device 40. The human body communication signal 45 and the user selection signal 62 are multiplexed on the x traces 110 and on the y traces 120

To distinguish the human body communication signal 45 from the user selection signal 62, filters may be used. As seen in FIG. 3, a series of high pass filters 130 is positioned between the x traces 110 and the y traces 120 to permit the relatively higher frequency human body communication signal 45 to pass to the human body communication controller 310 while blocking the relatively lower frequency user selection signal 62. Similarly, between the touch controller 200 and the y traces 120, a series of low pass filters 132 is positioned to permit the relatively lower frequency user selection signal 62 to pass while blocking the relatively higher frequency human body communication signal 45. In this manner, the multiplexed human body communication signal 45 and the user selection signal 62 are distinguished from one another at the respective controllers, the human body communication controller 310 and the touch controller 200. Thus a single set of conductive traces may be used to carry both the human body communication signal 45 and the user selection signal 62 multiplexed with each other without the need for a separate system to carry the human body communication signal 45.

As seen in FIG. 3, the human body communication controller 310 includes a transmit port 1 311, a transmit port 2 312, a receive port 1 313, and a receive port 2 314. Transmit port 1 311 and receive port 1 313 may communicate with the chassis 161 via a communication path 250. The chassis 161 may serve as an electrode to complete an electrical pathway. Transmit port 2 312 and receive port 2 314 may communicate with a set of traces, shown here as x traces 110 (although it is understood that y traces 120 may alternatively communicate with these ports or both x traces 110 and y traces 120 may communicate with both ports). Information bearing signals are emitted by the transmit port 1 311 and the transmit port 2 312 to be sent across the x and y traces 110 and 120 through the user body part 80 and to the human body communication device transmitter/receiver 41. The human body communication signal 45 that is transmitted by the human body communication device transmitter/receiver 41 passes through the user body part 80, through x traces 110 and y traces 120 and is received through receive port 1 313 and receive port 2 314 of the human body communication controller 310.

The human body communication controller 310 may communicate with a processor 300 via communication pathway 260. Similarly, the touch controller 200 may communicate with the processor 300 through a communication pathway 270. The processor 300 may perform an action requested by the user selection signal 62 and an action requested by the human body communication signal 45. For example, if the user selection signal is a paste operation, the processor 300 may cause the data in the human body communication signal 45 to be pasted for display on the touch device 160 of FIG. 3.

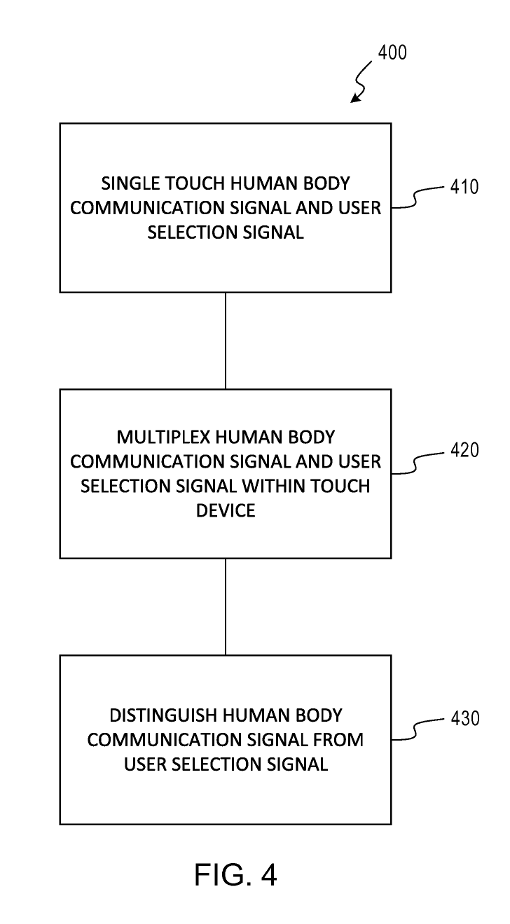

FIG. 4 shows a flowchart of an exemplary method 400 of human body communication with a touch device. The method 400 may be implemented as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 400 may be written in any combination of one or more programming languages, including an object oriented programming language such as Java, Smalltalk, C++ or the like and conventional procedural programming languages, such as the “C” programming language or similar programming languages.

Illustrated processing block 410 provides for receiving the human body communication signal 45 and the user selection signal 62 through a single touch to a touch device such as the touch device 60 or the touch device 160. In illustrated block 420, the received signals are multiplexed within the touch device 60 or the touch device 160. For example, the received human body communication signal 45 is multiplexed with the user selection signal 62 on the x traces 110 and the y traces 120 of the touch device 160. In illustrated block 430, the human body communication signal 45 is distinguished from the user selection signal 62 for example by filtering prior to the touch controller 200 and filtering prior to the human body communication controller 310.

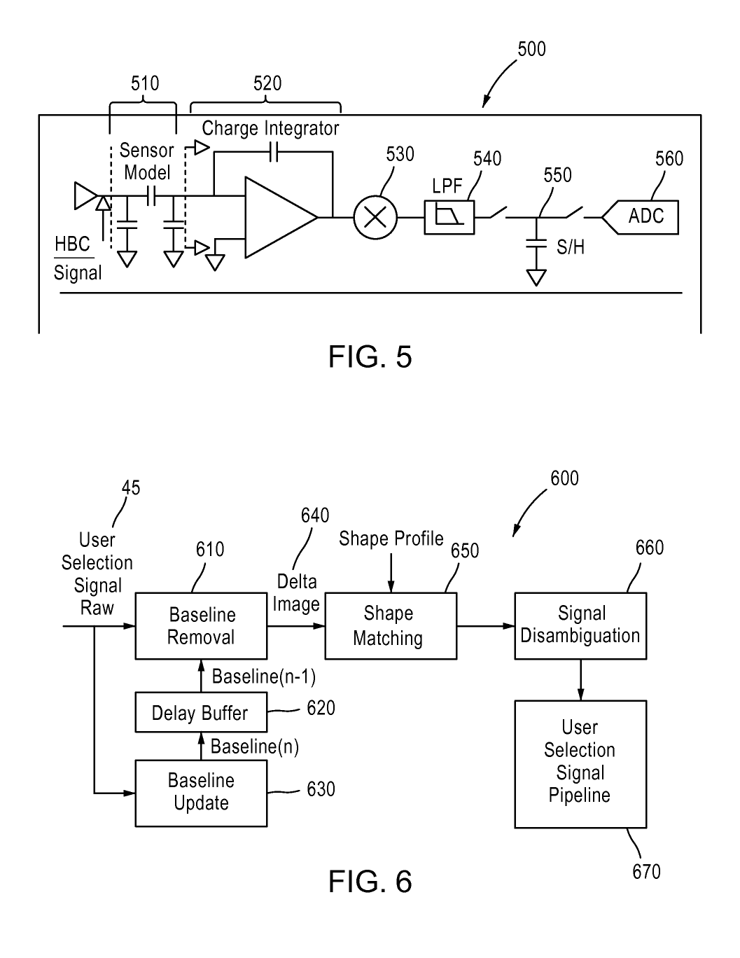

With continuing reference to FIGS. 2, 3 and 5, FIG. 5 depicts a signal processing model 500 that may be used in the touch device 60 or the touch device 160. The illustrated model 500 includes a sensing section 510 and a charge integration section 520. A mixer 530 may be positioned prior to a low pass filter 540 and a sample and hold section 550. During operation, an analog to digital converter 560 may convert an analog signal to a digital signal. A Nyquist frequency suitable for the higher frequency human body communication signal 45 may be selected. For example, if the human body communication signal 45 is at a frequency of 13.56 MHz, using a sampling frequency of around 27 MHz will be sufficient to convert both the human body communication signal 45 and the user selection signal 62 to digital signals. Thus the illustrated circuit 500 is able to support both the human body communication signal 45 and the user selection signal 62 as a single low cost device. Note that although analog components are shown in circuit 500, equivalent functions may be performed in software with analog to digital conversion positioned immediately following the charge integrator. In an exemplary embodiment software radio may perform the functions of illustrated model 500.

When power is supplied to the conductive traces 110 and 120, a two dimensional image of surface capacitance is generated. This is a baseline image at a time when no user body part 80 is in contact with the device 160. Subsequent images that are gathered are subtracted from the baseline image to provide a delta image. As the human body communication signal 45 is powered on and off, it may introduce a small signal level change to the user selection signal 62. The signal change may appear to be a region of positive or negative low amplitude in the delta image signal that the touch controller 200 detects. When there is no user body part 80 or any other portion of the human body contacting the touch device, this region of low amplitude signal can be absorbed by doing a continuous baseline update. However, if the human body communication signal 45 is powered on or off while a user body part 80 is in contact with the conductive traces 110 and 120, the baseline update will stop and the low amplitude signal region introduced by powering the human body communication signal 45 on and off will not be absorbed.

To compensate for this situation, a method 600 to distinguish the user selection signal 62 from the human body communication signal 45 is shown in FIG. 6. The method 600 generates a shape profile of a low amplitude region of a user selection signal 62 through illustrated baseline removal block 610 including a delay buffer block 620 and a baseline update block 630. A delta image 640 is formed at the output of the baseline removal block 610. At a shape matching block 650, the shape of the delta image 640 is compared to a known shape profile and the specific low-amplitude signal region that matches the shape can be removed at a signal disambiguation block 660. Following signal disambiguation, an output signal continues for further processing in a user selection signal pipeline 670.

Advantageously, human body communication described in the embodiments may have a variety of applications depending upon the specific data that is transmitted. Transmitted data may be information such as text from a document that is temporarily stored on a human body communication device (after being copied) and then transferred to another touch device such as a computer, smart phone, or tablet. Similarly it can be a URL that is later copied to another device or geo-coordinates that are later copied to a GPS navigation unit. The information transmitted from a touch device to a human body communication device may be a form of user credentials that were placed on the human body communication device by a third party. An example of a user-owned credential might be encryption keys used to decrypt an encrypted document sent to a secure printer. An example of third-party owned credentials may be account information placed on the human body communication device by a bank on behalf of a user. Information stored on the human body communication device may be information that identifies the user, such as biometric markers of the owner of the human body communication device. This information may be used to determine whether the person in possession of the human body communication device is the rightful owner.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Additional Notes and Examples:

Example 1 may include a human body communication system having a wearable human body communication device including a transmitter and receiver to send and receive human body communication signals through at least a portion of a human body, a touch device having conductive traces to receive the human body communication signals at a first frequency and user selection signals at a second frequency such that the human body communication signals and the user selection signals are multiplexed together on the conductive traces; and a processor to receive the human body communication signals and the user selection signals.

Example 2 may include the system of example 1, further including a human body communication controller communicating with the conductive traces.

Example 3 may include the system of examples 1 or 2, further including a touch controller communicating with the conductive traces.

Example 4 may include the system of examples 1 or 2, further including analog filters to separate the human body communication signals from the user selection signals.

Example 5 may include the system of examples 1 or 2, wherein the wearable human body communication device further includes a wireless transmitter and receiver.

Example 6 may include the system of examples 1 or 2, further including a touch controller.

Example 7 may include an apparatus to receive human body communication signals including a touch device having conductive traces to receive human body communication signals at a first frequency and user selection signals at a second frequency such that the human body communication signals and the user selection signals are multiplexed together on the conductive traces; and a processor to receive the human body communication signals and the user selection signals.

Example 8 may include the apparatus of example 7, further including a human body communication controller communicating with the conductive traces.

Example 9 may include the apparatus of examples 7 or 8, further including a touch controller communicating with the conductive traces.

Example 10 may include the apparatus of examples 7 or 8, further including analog filters to separate human body communication signals from user selection signals.

Example 11 may include the apparatus of examples 7 or 8, further including digital filters to separate the human body communication signals from the user selection signals.

Example 12 may include the apparatus of examples 7 or 8, further including a first communication path between the human body communication controller and the processor and a second communication path between the touch controller and the processor.

Example 13 may include a method of human body communication including receiving, via a single touch by a user, a human body communication signal at a first frequency and a user selection signal at a second frequency different from the first frequency; multiplexing the human body communication signal and the user selection signal onto conductive traces; and distinguishing the human body communication signal from the user selection signal.

Example 14 may include the method of example 13, further including performing, by the processor, one or more actions requested by the human body communication signal and one or more actions requested by the user selection signal.

Example 15 may include the method of examples 13 or 14, further including using a digital filter to separate the human body communication signal from the user selection signal.

Example 16 may include the method of examples 13 or 14, further including using an analog filter to separate the human body communication signal from the user selection signal.

Example 17 may include the method of examples 13 or 14, wherein the wherein the conductive traces are part of a touch device.

Example 18 may include the method of examples 13 or 14, wherein the first frequency is in a range from approximately 1 MHz to approximately 60 MHz and second frequency is in a range from approximately 100 kHz to approximately 900 kHz.

Example 19 may include a non-transitory computer readable medium comprising a set of instructions which, when executed by a processor cause a local device to multiplex a received human body communication signal at a first frequency with a user selection signal at a second frequency different from the first frequency onto conductive traces; distinguish the human body communication signal from the user selection signal; and perform one or more actions requested by the human body communication signal and one or more actions requested by the user selection signal.

Example 20 may include the computer readable medium of example 19, wherein distinguishing the human body communication signal from the user selection signal comprises digital filtering.

Example 21 may include the computer readable medium of example 19, wherein distinguishing the human body communication signal from the user selection signal comprises analog filtering.

Example 22 may include an apparatus to receive human body communication signals having means for receiving, via a single touch by a user, a human body communication signal at a first frequency and a user selection signal at a second frequency different from the first frequency, means for multiplexing the human body communication signal and the user selection signal onto conductive traces; and means for distinguishing the human body communication signal from the user selection signal.

Example 23 may include the apparatus of example 22, further including means for performing one or more actions requested by the human body communication signal and one or more actions requested by the user selection signal.

Example 24 may include the apparatus of examples 22 or 23, further including digital filtering means for separating the human body communication signal from the user selection signal.

Example 25 may include the apparatus of examples 22 or 23, further including analog filtering means for separating the human body communication signal from the user selection signal.

Example 26 may include the apparatus of examples 22 or 23, further comprising touch controller means.

Example 27 may include the apparatus of examples 22 or 23, further including touch controller means.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system comprising:
a wearable human body communication device including a transmitter and receiver to send and receive human body communication signals through at least a portion of a human body;
a touch device having conductive traces to receive the human body communication signals at a first frequency and user selection signals at a second frequency such that the human body communication signals and the user selection signals are multiplexed together on the conductive traces; and
a processor to receive the human body communication signals and the user selection signals.

2. The system of claim 1, further comprising a human body communication controller communicating with the conductive traces.

3. The system of claim 1, further comprising a touch controller communicating with the conductive traces.

4. The system of claim 1, further comprising analog filters to separate the human body communication signals from the user selection signals.

5. The system of claim 1, wherein the wearable human body communication device further includes a wireless transmitter and receiver.

6. The system of claim 1, further comprising digital filters to separate the human body communication signals from the user selection signals.

7. An apparatus comprising:
a touch device having conductive traces to receive human body communication signals at a first frequency and user selection signals at a second frequency such that the human body communication signals and the user selection signals are multiplexed together on the conductive traces;
a processor to receive the human body communication signals and the user selection signals.

8. The apparatus of claim 7, further comprising a human body communication controller communicating with the conductive traces.

9. The apparatus of claim 7, further comprising a touch controller communicating with the conductive traces.

10. The apparatus of claim 7, further comprising analog filters to separate the human body communication signals from the user selection signals.

11. The apparatus of claim 7, further comprising digital filters to separate the human body communication signals from the user selection signals.

12. The apparatus of claim 7, further comprising a first communication path between the human body communication controller and the processor and a second communication path between the touch controller and the processor.

13. A method comprising:
receiving, via a single touch by a user, a human body communication signal at a first frequency and a user selection signal at a second frequency different from the first frequency;
multiplexing the human body communication signal and the user selection signal onto conductive traces; and
distinguishing the human body communication signal from the user selection signal.

14. The method of claim 13, further comprising performing, by a processor, one or more actions requested by the human body communication signal and one or more actions requested by the user selection signal.

15. The method of claim 13, further comprising using a digital filter to separate the human body communication signal from the user selection signal.

16. The method of claim 13, further comprising using an analog filter to separate the human body communication signal from the user selection signal.

17. The method of claim 13, wherein the conductive traces are part of a touch device.

18. The method of claim 13, wherein the first frequency is in a range from approximately 1 MHz to approximately 60 MHz and second frequency is in a range from approximately 100 kHz to approximately 900 kHz.

19. A non-transitory computer readable medium comprising a set of instructions which, when executed by a processor cause a local device to:
multiplex a received human body communication signal at a first frequency with a user selection signal at a second frequency different from the first frequency onto conductive traces;
distinguish the human body communication signal from the user selection signal; and
perform one or more actions requested by the human body communication signal and one or more actions requested by the user selection signal.

20. The computer readable medium of claim 19 wherein distinguishing the human body communication signal from the user selection signal comprises digital filtering.

21. The computer readable medium of claim 19 wherein distinguishing the human body communication signal from the user selection signal comprises analog filtering.
